(19) United States
(12) Patent Application Publication
(10) Pub. No.: US 2018/0118582 A1
(43) Pub. Date: May 3, 2018

(54) METHOD OF HYDRATING A PERFORMANCE ANIMAL WHEN TRAVELING

(71) Applicant: Chism Technologies, LLC, Merrill, WI (US)

(72) Inventors: Kasey Chism, Merrill, WI (US); Jeff Chism, Merrill, WI (US); Sheryl Chism, Merrill, WI (US)

(21) Appl. No.: 15/796,148

(22) Filed: Oct. 27, 2017

Related U.S. Application Data
(60) Provisional application No. 62/414,323, filed on Oct. 28, 2016.

(51) Int. Cl. C02F 1/28; A23K 50/20

(52) U.S. Cl. CPC C02F 1/28; A23K 50/20; C02F 2101/203; C02F 1/281; C02F 1/283; C02F 2303/02

(57) ABSTRACT

A method of hydrating an animal when traveling includes steps of: (a) traveling from a first location where the animal is accustomed to the taste and/or odor of water at the first location to a second location where water at the second location has a taste and/or odor different from the water at the first location; (b) flowing the water at the second location through a water filter to provide second location filtered water; and (c) making the second location filtered water available to the animal at the second location.

### CROSS REFERENCE TO RELATED APPLICATION

This application claims priority to U.S. Provisional Application Ser. No. 62/414,323 filed with the United States Patent and Trademark Office on Oct. 28, 2016. The entire disclosure of U.S. Provisional Application Ser. No. 62/414,323 is incorporated herein by reference.

### FIELD OF THE DISCLOSURE

The present disclosure relates to a method of hydrating a performance animal when traveling. In particular, the disclosure relates to a method of hydrating an equine animal when traveling.

### BACKGROUND

It is often necessary for horses to travel away from home to compete in various events such as races, horse shows, or equestrian events such as dressage, eventing, hunter, and equitation. As a result of such travels, the horses may encounter water at the new location that is different in taste and/or odor compared with the water that they are used to drinking at their home. Because of this difference in flavor and/or odor, the horses often refuse to drink sufficient amounts of water. As a result of this, horses are often asked to perform in a dehydrated state relative to their normal hydrated condition at their home.

It is recognized that a 2% reduction in water intake for a horse can result in a 10% to 20% reduction in performance. See http://equinechronicleonline.com/performance-horses-and-the-importance-of-hydration/. In addition, dehydration can be unhealthy for horses, and can result in injury. Accordingly, it is desirable to keep horses fully hydrated when traveling so that the horses can perform to their potential at their travel destination.

In order to address the refusal by horses to drink adequate amounts of water when traveling, it is often necessary to carry additional water with the horses. By carrying water that the horses are used to drinking (for example, home water), it is likely the horses will continue drinking water to avoid dehydration. However, carrying additional water can be very expensive, and the additional water can consume a considerable amount of space. Alternatively, flavorants are sometimes added to the water when traveling to mask or hide any off flavor and/or odor. Adding flavorants to water as a technique to prevent horses from refusing to drink sufficient amounts of water has experienced mixed success. Alternative techniques to keep horses hydrated, when traveling, so that the horses can perform in a fully hydrated state are desired.

### SUMMARY

A method of hydrating an animal when traveling is provided according to the present disclosure. The method includes steps of: (a) traveling from a first location where the animal is accustomed to the taste and/or odor of water at the first location to a second location where water at the second location has a taste and/or odor different from the water at the first location; (b) flowing the water at the second location through a water filter to provide second location filtered water; and (c) making the second location filtered water available to the animal at the second location. The water filter includes: (i) a housing having a water inlet, a water outlet, and a housing body extending between the housing inlet and the housing outlet; (ii) a first screen located within the housing body downstream of the water inlet, and a second screen located within the housing body upstream of the housing outlet; and (iii) filter media provided as a solidified block form and in a cylindrical shape and located within the housing body between the first screen and the second screen.

The method can include additional steps of: (a) flowing the water at the first location through the filtration unit to provide first location filtered water; and (b) making the first location filtered water available to the animal at the first location.

The animal can be provided as an equine animal.

### BRIEF DESCRIPTION OF THE DRAWINGS

FIG. 1 shows a method of hydrating an animal according to the principles of the present disclosure.

FIG. 2 shows a sectional view of a filtration unit used in the method illustrated in FIG. 1.

### DETAILED DESCRIPTION

The present disclosure relates to a method of hydrating an animal as a result of traveling. Exemplary animals that can be hydrated by the method of the present disclosure include equine animals such as horses and ponies. Various other animals that can be hydrated by the present disclosure include swine, sheep, cattle, goats, and other livestock. The animal can become accustomed to the flavor or taste and/or odor of water at a first or home location. The first or home location can be the location where the animal typically lives and trains, and where the animal becomes accustomed to the water. Often, when the animal travels to a new or second location, the water will be different as a result of a different flavor, taste, and/or odor. Certain animals, such as horses, have very sensitive taste and smell senses, and a change in the taste and/or odor of the water may result in a refusal by the animal to take sufficient amounts of water to maintain adequate hydration. In the case of horses, it is generally recognized that a 2% reduction in water intake can result in a 10% to 20% reduction in performance. In addition, it often takes a considerable amount of time for a horse to adjust to the water at the new or second location so that the horse takes sufficient amounts of water to become fully hydrated. In addition, sometimes the local water at the new or second location includes undesirable amounts of certain chemicals such as chlorine, soluble heavy metals, iron, and hydrogen sulfides. When such chemicals are present in the water, it is desirable to remove or reduce the level of those chemicals in the drinking water.

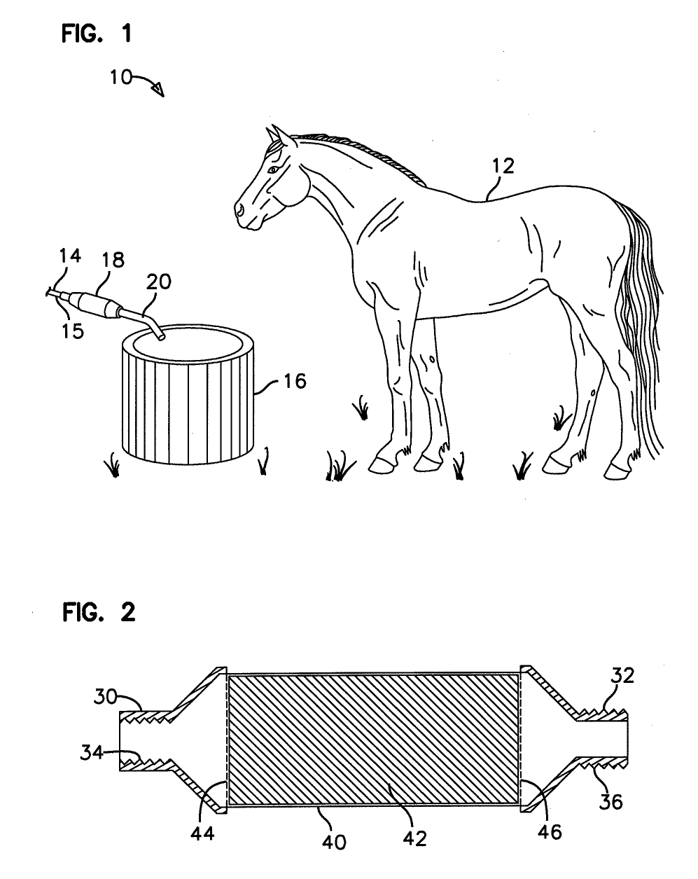

Now referring to FIG. 1, a method of hydrating an animal is illustrated at reference number 10. The method is illustrated in the context of a horse 12. Local water flows through a water conduit 14 and into a trough 16. Attached to the water conduit 14 is a filtration unit 18 for filtering the water. The water conduit 14 can be provided as a conventional water hose 15. Furthermore, a second water conduit or hose 20 can be provided for delivering filtered water from the filtration unit 18 to the trough 16.

The source of the water is preferably a municipal water source or well water source that provides potable water. The phrase “potable water” refers to water that is micro-biologically safe so that it does not cause an infection. Even though the water is potable, it still may contain particulates and/or chemicals such as chlorine, soluble heavy metals, iron, and hydrogen sulfides. By filtering the water, the level of the particulates and/or the chemicals can be reduced. In addition to using the filtration unit 18 when traveling or when at a second or new location, the filtration unit 18 can be used to provide filtered water at the home or first location for providing a reduction in the level of the particulates and/or chemicals and/or for removing undesired taste and/or order from the water. By filtering the water at both the first or home location and the second or new location, it is expected that the water available to the horse will be more consistent. It is expected that this will result in a greater likelihood that the horse will maintain its hydration at a desired or healthy level.

Now referring to FIG. 2, the filtration unit 18 is illustrated in a sectional view. The filtration unit 18 includes an untreated water inlet 30 and a filtered water outlet 32. The water inlet 30 is shown having internal threads 34 for engaging a standard water hose outlet. The filtered water outlet 32 includes external threads 36 for attaching an optional second conduit or hose thereto. Between the inlet 30 and the outlet 32 is a filter body 40 that contains the filtration media 42. Furthermore, an inlet screen 44 and an outlet screen 46 help contain the filtration media 42 within the housing 40. The filtration media 42 can be provided as a solid mass 50 that generally resists crumbling or disintegration. The mass 50 can be referred to as a block. The filtration media 42 can be provided as a combination of KDF-55 (or KDF-85) process media and coconut carbon. In general, KDF-55 process media and KDF-85 process media are high purity copper-zinc granule combinations that can be used for filtering water to decrease chlorine, iron, lead, mercury, hydrogen sulfide, magnesium, calcium carbonate, chromium, algae, fungi, bacteria, and various additional harmful contaminates. Coconut carbon can be considered a carbon filter media prepared by subjecting coconut husks to pyrolysis. Preferably, the weight ratio of process media to coconut carbon can be about 25 wt. % to about 75 wt. % process media to about 75 wt. % to about 25 wt. % coconut carbon. Furthermore, the weight ratio can be about 40 wt. % to about 60 wt. % process media to about 60 wt. % to about 40 wt. % coconut carbon. Preferably, the weight ratio is about 50 wt. % process media to about 50 wt. % coconut carbon. The filtration media 42 can have a pore size sufficient to provide a water flow rate through the filtration unit 18 of about 5 gallons per minute. The pore size should not be so great that the water is permitted to flow through without removal of contaminates therefrom, and should not have a size so small that back pressure results in insufficient water flow. Preferably, the filtration media 42 has an average pore size of about 5 microns to about 10 microns. The filtration unit can provide a horse with filtered water for a period of about 4 months or provide about 700 to 2,000 gallons of filtered water. Of course, the life of a given filtration units depends on the level of particulates and/or chemicals in the water.

In general, the filtration unit 18 provides for filtration of portable water (for example, municipal or well water) at the location of the horse and thereby removes or reduces off taste, odors, sediment, and certain chemicals that may be present in the water in order to provide the horse with a water source for consumption that is similar to the water source the horse is accustomed to drinking.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of hydrating an animal when traveling, the method comprising:
(a) traveling from a first location where the animal is accustomed a taste and/or odor of water at the first location to a second location where water at the second location has a taste and/or odor different from the water at the first location;
(b) flowing the water at the second location through a water filter to provide second location filtered water, the water filter comprising:
(i) a housing having a water inlet, a water outlet, and a housing body extending between the housing inlet and the housing outlet;
(ii) a first screen located within the housing body downstream of the water inlet, and a second screen located within the housing body upstream of the housing outlet;
(iii) filter media provided as a solidified block form and in a cylindrical shape and located within the housing body between the first screen and the second screen; and
(c) making the second location filtered water available to the animal at the second location.

2. A method of hydrating an animal according claim 1, wherein the animal comprises an equine animal.

3. A method of hydrating an animal according to claim 1, wherein method further comprises:
(a) flowing the water at the first location through a filtration unit to provide first location filtered water; and
(b) making the first location filtered water available to the animal at the first location.

4. A method according to claim 3, wherein the filter at the second location and the filter at the first location are the same filter.

5. A method of hydrating an animal according to claim 1, wherein the water at the second location comprises well water.

6. A method of hydrating an animal according to claim 1, wherein the water at the second location comprises municipal water.
